(19) United States
(12) Patent Application Publication
(10) Pub. No.: US 2018/0060910 A1
(43) Pub. Date: Mar. 1, 2018

(54) System and Method of Real Time Deal Notification to People Nearby

(71) Applicants: Ashutosh Shrivastav, Silver Spring, MD (US); Riti Patel, Silver Spring, MD (US)

(72) Inventors: Ashutosh Shrivastav, Silver Spring, MD (US); Riti Patel, Silver Spring, MD (US)

(21) Appl. No.: 15/157,406

(22) Filed: May 18, 2016

(51) Int. Cl. G06Q 30/02; H04L 29/08; H04L 12/58

(52) U.S. Cl. CPC G06Q 30/0259; H04L 67/32; H04L 67/18; H04L 67/02; G06Q 30/0276; G06Q 30/0255; G06Q 30/0267; G06Q 30/0264; G06Q 30/0257; H04L 51/24

(57) ABSTRACT

This invention is about computer software and mobile-device-implemented methods, services and user interfaces for allowing a set of user or users to notify of special offers to other set of user or users. Utilizing this method and location based GPS technology, a set of user creates data which is stored in a middle layer such as a cloud system or database and then displayed on the other set of user's device. In this method, one set of user creates data and another set of user receives data. The data passes through the middle layer, identifies the devices in a defined latitude and longitude and displays the data on those devices. This data could be created from and received on various independent platforms using their API or tools specifically created for the data creation and receiving function.

### USAGE

The document contains an application of the invention that is provided as a commercially-available service, known as the Salereporter, that embodies some of the features of the invention. The application in Salereporter is intended to illustrate an example commercial implementation, and not to define or limit the scope of the invention.

### FIELD OF THE INVENTION

The present invention relates to computer and mobile-implemented services and user interfaces for allowing businesses to notify special offers to the people nearby. It relates to the method by which a business creates an offer and delivers the offer to the users. It notifies people nearby using geo location data gathered from user devices. The invention also relates to methods for users to install the software application on their mobile devices, select nearby businesses who they want to hear from and receive notifications for deal offers.

### BACKGROUND ON THE INVENTION

Various web and mobile based services have been developed for allowing businesses to notify people of the sale, discounts, deals (“deals”). Examples of such services include Coupons.com and RetailMeNot. Users have typically received the deal notifications via mail or electronic media such as email, deal website or deal mobile application. These services generally suffer from a number of deficiencies.

One such deficiency is that the coupons offered by businesses are for longer period of time. This is typically at least more than one day. These coupon offers are not priced according to the demand and supply of the day and time during which the coupon was issued. For example, if a business issues a coupon on January 1 that states that a customer would get a “10% discount on coffee” with the coupon expiration date of January 30, that coupon discount is static—in this case 10%. This 10% value is not derived from actual supply and demand of coffee on January 25. It is also not derived from the number of visitors that the business would have on January 25. Additionally, with coupon there is a risk of it expiring and not being used since majority of the people tend to procrastinate and end up not using the coupon.

Another deficiency is that the existing deal platforms do not have the capability to allow a business to notify of deals to the people in the area without user intervention. Local customer reach has been tried by several platforms but each of them requires the users to engage or open the application through which the user is notified of the deal such as mobile application, website or email. For example, user must log into a website, open a mobile application or email to see the deals around them.

Another deficiency is that the businesses typically must complete a significant number of setup steps before they could join the deal platform and offer deals. Moreover, the existing deal platform providers focus only large businesses who have a bigger presence. As a result, existing services are not well suited for small businesses. The need to offer deals may arise for small businesses as well, for example, when a business wishes to offer deals when the business sees very few people in their store.

Another deficiency is that the coupons issued by the business has only limited items. It is also static. Once it is printed either in paper or electronic form, it remains static. For example, a typical coupon includes the item that is offered, discounted price and validity. If the business wants to offer another item, it would need to issue a new coupon.

Another deficiency is that the user must open the deal service provider's mobile application, software application or website to discover or use the deal.

Prior deal platform services also typically lack the ability for businesses to notify users who are present only within a certain distance using the GPS location data. This lack of feature also results in poor experience for the users as they receive notifications of offers that is of no value for them. For example, a social network facebook allows businesses to target users within certain distance from the business. However, it is not dependent on location data, does not show the notification when the service application is closed, user must open the application to see the deal and also the user may or may not see the deal. As a result, businesses do not effectively reach the users.

Other deal platform services also typically do not provide the users specific deals in the location where the user is located when the user's location is dynamically changing based on the user's movement. For example, if a user moves from location A to B and the distance between A and B is ten miles, the user misses the deals while commuting from location A to B.

### SUMMARY OF THE INVENTION

This invention addresses the above and other problems by providing an effective deal notification system that is valuable for both businesses and the users. These features may be implemented individually, or in an appropriate combination. These services may be implemented through a website or a mobile device website or software application. This invention introduces following features.

One feature of the invention allows businesses to register their information and save their location latitude and longitude on the deal notification platform. Business can choose from multiple categories in which the business operates in. For example, a restaurant that operates like a bar for late night hours could categorize itself as a restaurant and bar.

Once the business information is saved in the deal notification platform system, a business can price and offer deals to the users nearby based on the customer traffic, item inventory, season of the year or even the weather. Business can calculate the price based on any given number of variable and offer a deal instantly. For example, if a coffee shop notices that the business is very slow around 11 AM, it can offer a x % discounted coffee deal which could be sent instantly to the users. Users' location data is tracked by the software application and matched against the location data of the business offering the deal. Hence only users in close proximity would receive the notification. This proximity is variable distance set by the platform or by the user preference.

Another feature of the invention allows users to receive deal offers via push notifications on their mobile device. User can download software application and receive offer notifications from the businesses nearby in the form of push notifications.

Users start receiving deals notifications after they install the software in their device or enable the software to send deal notifications through an application programming interface and set their preferences from whom they want to receive notifications. No further action is needed by the users to continue the benefits of the software application and offers. This one time install is particularly valuable. First, in order to use the deal offers from other service providers, users must click on the software application to open the application. Second, users typically must search for the available offers. Third, users must redeem the offer either by using the code provided by the issuer or the user must show the offer details to claim the benefit. This invention lets user benefit the deal offers without the preceding steps. By using this invention, users just need to install the app once. In order to take the benefit of the offer, they do not need to click or open the software or show any coupon code.

### BRIEF DESCRIPTION OF THE DRAWINGS

FIG. 1 is the interface for a business to join the deal offering platform. A business provides the information of the owner or manager, contact information, business details and contact information. In the next step, the business points itself to a location on the map. This location's latitude and longitude is then stored in the server.

FIG. 2 is the interface provided to the business to offer a deal. Business writes the details of what it intends to offer, validity begin date and time, and validity end date and time.

FIG. 3 lists the history of the deals the business has offered in the past. With one click, the business can also activate the same offer.

FIG. 4 is the software that will act as a client for the deal notifications to be delivered. In this case, the software is installed on the device.

FIG. 5 shows the various categories and businesses a user can select to receive deal notifications from. The user can also choose the distance from businesses the user is willing to get notification from. For example, the user can choose to receive a deal notification by a Coffee Shop located within 10 miles of the user's location and if the deal is offered between 1 PM to 2 PM. User can keep the criteria very broad to hear from all businesses or very narrow limiting to hear from only select businesses.

FIG. 6 shows that the user has completed setting the preferences from which businesses the users want to get notifications. This step completes the software installation process. No further action is necessary to be taken by the user to receive the notification offers and using them.

FIG. 7 is a sample notification that shows up as a push notification on the users' device. This figure shows the same messages that are written by the business in FIG. 2. Business location in FIG. 1 is matched with the location of the user to send the notification.

FIG. 8 is the list of the active deals notified to the user. As the deals expire or the user moves to a different location, this list gets updated. Active deals in the new location appear on the screen and the deals no longer in the location or no longer active are removed.

FIG. 9 shows that a user can take an action on the notification. It shows the action link is hyperlinked to provide value to the user and also to other service providers.

FIG. 10 shows sample actions that users can take to use the offer for example, reserve a table, order ahead and pay online for pickup or delivery.

FIG. 11 shows the option for users to edit the preferences on the business they want to hear from.

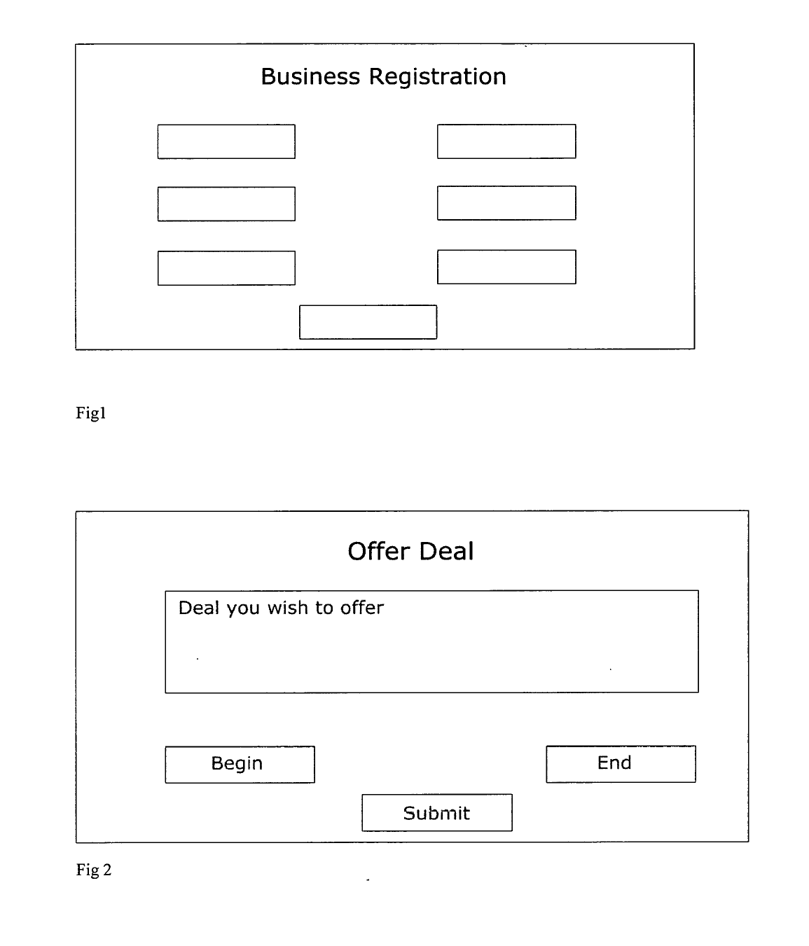

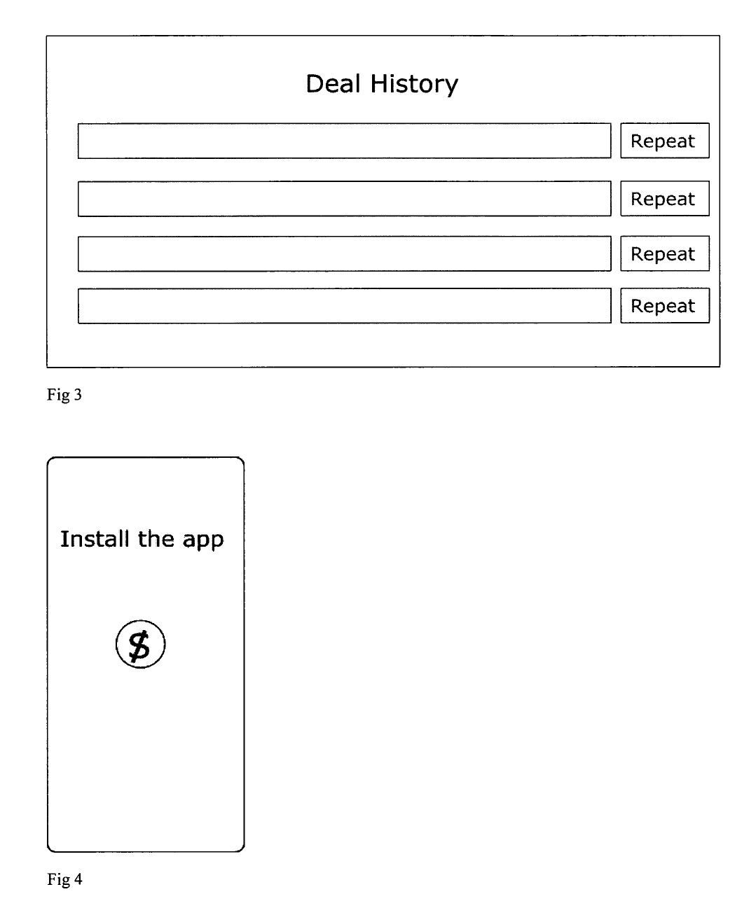

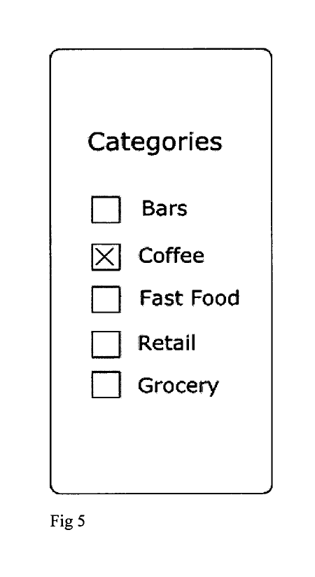

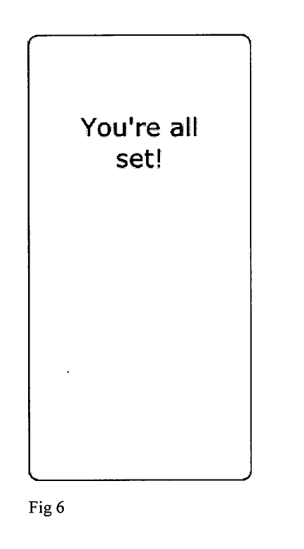

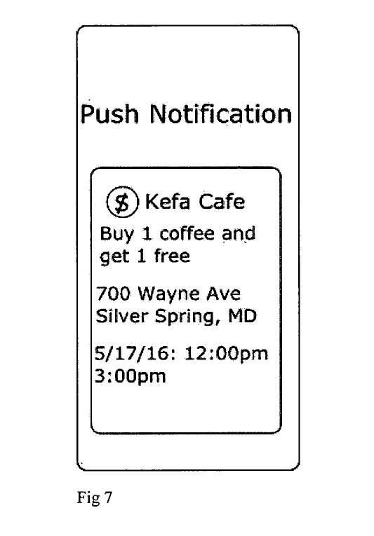

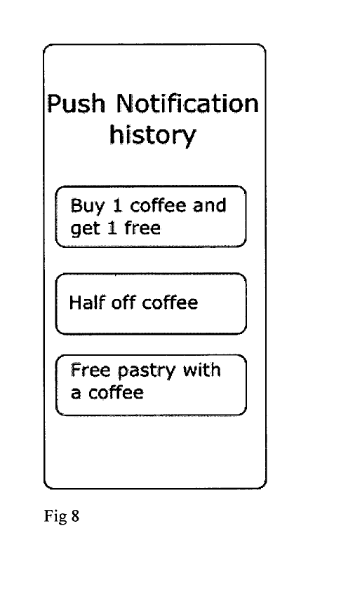

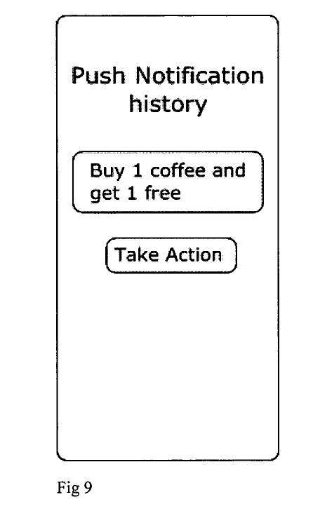

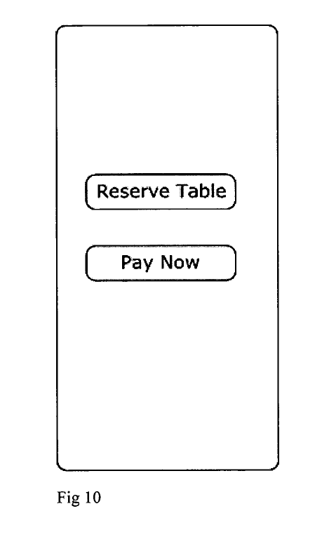

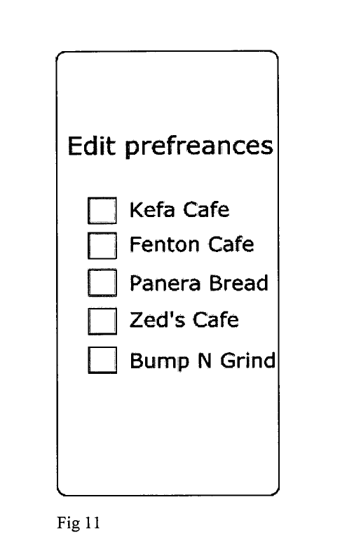

### DETAILED DESCRIPTION

1. Offer Deals

This process sends an offer that a business is willing to extend to locals. Businesses register for the platform, for example, Salereporter website or Salreporter Mobile App. In the platform, the business can type a customized offer. Business then selects or types the date and time the offer is valid from and the expiration date and time the offer expires. Once the business writes what it is offering and validity period, it can push the details to the server. The server delivers the offer details in the form of push notification.

The user sees the offer details and the validity time period. User does not need to click on the phone to see the offer.

By using this invention, businesses can reach out to potential customers for example, when their foot traffic is low. Businesses can use this invention for a variety of other reasons, including but not limited to, reaching out to local potential customers during lunch special, a new product launch, specials of the day, deal of the day, happy hours or anything that brings the value to the business.

### EXAMPLE

In this example, Business B sends a deal notification to Users U.

### Steps:

1) Business B creates a deal offer. Deal offer may contain these fields including but not limited to.
a) Details of the offer.
b) Offer start time
c) Offer end time
d) Business name
e) Business location
f) Business contact information

2) Business B launches the offer.

2. Receiving Deal Offers

Users install the software on their devices, and optionally save preferences from which businesses they want to hear special offers from. They can select from the business categories, name of business, area in the map, or other selection criteria to tailor their interests. Once the software is installed in the device, users do not need to click, open or navigate through the software since the offers are delivered as push notifications.

User location data is continuously updated on the service provider's system. As user moves in new location, users' location is checked against the location of the business who is offering a deal specific to the interest of the user. If the user and business location data are in close proximity, for example, fifteen miles, and if the interest of the user matches with the deal offered by the business, the user is notified.

3. Dynamically Priced Automated Offers

Offers are created automatically by the system for the businesses. In this automated process, a business is not required to create the offers manually. Based on the data gathered from the business such as the price the time of the day when the business experiences less foot traffic, less sales, excess inventory, competitor offers, deal offer system automatically creates the offer and sends to the users. For example, if a business has experienced slow foot traffic between 11 AM to 1 PM in the past six months, the system automatically creates an offer that is valid for this time period.

4. Search

Using a mobile device, this invention uses geo-location with GPS to allow a user search for businesses offering deals within their immediate vicinities. The search is map based wherein the businesses with offers are displayed on the map on the vicinity of the member's location. Users also have the ability to search for the category of business, location, offer type, business name and several other criteria. For example, if User A is interested in hearing from Starbucks Coffee within 1 miles of his location, user can search and specify these criteria on the software application. When Starbucks Coffee within one mile of this user offers a deal, User A is notified of the deal.

What is claimed:

1. A system and deal notification process using software application, mobile application or web site, comprising:
a module providing the functionality for the businesses to offer deals to the people nearby their business based on location data;
a module providing the functionality for the businesses to price items for discount based on the various variable information available at that time when the deal is being issued which otherwise must be predicted or guessed;
a module providing the functionality for businesses to offer a deal that is timed and can be issued instantly;
a module providing the functionality for businesses to choose start and end time for their offer giving them total flexibility;
a module providing the functionality for the businesses to type a deal that they want to offer which is sent as a push notification;
a module providing the functionality for the users to receive deal notification that does not require user to click, open, type or use any codes, show the offer to receive the offer
a module providing the functionality for the users to receive deal notifications
a module which keeps on running in the users background and activates only when the business if offering a deal based on user preference and location data
a module providing the functionality for the users to invite other users with the application
a module providing the functionality for the users to search and select the criteria of the businesses the users are interested to get notifications from

2. The system of delivery of deal offers to users from businesses using push notification system in claim 1, further comprising of the system wherein the offers sent by businesses are delivered as push notification in users' mobile device,

3. The system as in claim 1, further comprising of business profile creation module, wherein a business enters data in the system;

4. The system as in claim 1, further comprising of a deal offer creation module wherein a business creates an offer;

5. The system as in claim 1, further comprising of an automated deal creation module wherein a business can enter the deals with set criteria such as when to active the automated deals

6. A method for deal notification process comprising;
a method to offer deals to the people nearby;
a method for the businesses to price items for discount based on the various variable information available at that time when the deal is being issued which otherwise must be predicted or guessed;
a method for businesses to offer a deal that is timed and can be issued instantly;
a module providing the functionality for businesses to choose start and end time for their offer;
a method for the businesses to type a deal that they want to offer
a method wherein deals are notified by push notification;
a method of deal notification that does not require user to click, open, type or use any codes, show the offer to receive the offer
a method through which the users receive deal notifications
a method of deal notification which keeps on running in the background and activates only when the business if offering a deal based on user preference and location data
a method through which the users search and select the criteria of the businesses the users are interested to get notifications from

7. The method as in claim 6, wherein a business send a deal notification to people nearby the business;

8. The method as in claim 6, wherein a business prices the items or lists an item for deal based on many information available at that time when the deal is issued which otherwise must be predicted or guessed;

9. The method as in claim 6, wherein a business can offer a timed deal that is set to begin instantly and expire within few hours;

10. The method as in claim 6, wherein a business can input the details of the deal;

11. The method as in claim 6 wherein the deals are sent via a push notification;

12. The method as in claim 6, wherein a user does not need to engage with the system to view or use the offer;

13. The method as in claim 6, wherein the system for deal notification keeps on running in the background and activates only if the set criteria of the users are met.
